(19) United States
(12) Patent Application Publication
(10) Pub. No.: US 2013/0196640 A1
(43) Pub. Date: Aug. 1, 2013

(54) Network Elements for End-to-End (E2E) Circuit Service (CS) Call Tracing Functionality

(71) Applicants: Chunbo Wang, Shanghai (CN); Haibin Chu, Shanghai (CN); Zhenghao Dong, Shanghai (CN); Klaus Turina, Herzogenrath (DE); Mingqiu Xu, Shanghai (CN)

(72) Inventors: Chunbo Wang, Shanghai (CN); Haibin Chu, Shanghai (CN); Zhenghao Dong, Shanghai (CN); Klaus Turina, Herzogenrath (DE); Mingqiu Xu, Shanghai (CN)

(73) Assignee: TELEFONAKTIEBOLAGET L M ERICSSON (PUBL), (SE)

(21) Appl. No.: 13/816,006

(22) PCT Filed: Sep. 19, 2010
(86) PCT No.: PCT/CN2010/077110

§ 371 Date: Mar. 21, 2013

(30) Foreign Application Priority Data
Aug. 10, 2010 (CN) PCT/CN2010/075863

(51) Int. Cl. H04W 4/16

(52) U.S. Cl. CPC H04W 4/16
USPC 455/414.1

(57) ABSTRACT

According to the invention, it provides a Network Element (NE) acting as an originating NE for End-to-End (E2E) Circuit Service (CS) call tracing functionality, the NE comprising: a receiver configured to receive a trace activation message which contains trace control and configuration parameters, wherein the trace control and configuration parameters include at least a Trace Reference, a start triggering event, a stop triggering event, an E2E call tracing option and an address of a Trace Collection Entity; a storage device configured to store the trace control and configuration parameters received by the receiver; a trace data reporter configured to start a trace session with the Trace Reference, to start a Trace Recording Session with a Trace Recording Session Reference when the start triggering event occurs, and to record and output trace data according to the stored trace control and configuration parameters; and a sender configured to detect that the E2E call tracing option is included in the trace activation message, and to include/send a trace extension field in a protocol signaling message towards a next NE, wherein the trace extension field includes at least the Trace Reference, the Trace Recording Session Reference, and the address of the Trace Collection Entity, wherein the trace data reporter is further configured to stop the Trace Recording Session when the stop triggering event occurs. Also, the present invention provides an NE acting as an intermediate NE and an NE acting as a terminated NE both for the E2E CS call tracing functionality.

### FIELD OF THE INVENTION

The invention relates to wireless communication systems, and more particularly, to a scheme for providing End-to-End (E2E) Circuit Service (CS) call tracing functionality and relevant network elements therefor.

### BACKGROUND OF THE INVENTION

In 3^{rd} Generation Partnership Project (3GPP), the concept of trace functions has been proposed and studied.

There are the following terms and definitions in 3GPP Technical Specifications for trace functions:
Trace:
   general term used for Subscriber, User Equipment (UE) and Service Trace (Service Trace is only for IP Multimedia Subsystem (IMS)).
Trace Session:
   time interval which is started with a Trace Session Activation and lasts until the Deactivation of that specific Trace Session (see FIG. 1).
Trace Reference:
   identifies a Trace Session and is globally unique.
Trace Recording Session:
   time interval within a Trace Session while trace records are generated for the Subscriber, UE or Service being traced. The triggering events starting and stopping a Trace Recording Session are also defined in 3GPP Technical Specifications.
Trace Recording Session Reference:
   identifies a Trace Recording Session within a Trace Session.

In particularly, FIG. 1 is a schematic diagram for illustrating the concepts of Trace Session and Trace Reference.

Referring to FIG. 1, the Trace Session 110 is started with a Trace Session Activation 120 which contains the following parameters:
International Mobile Subscriber Identification number (IMSI) for Subscriber Trace, International Mobile Equipment Identity (IMEI) or IMEI Software Version (IMEI(SV)) for UE Trace, or Public ID for Service Trace;
Trace Reference; and
Trace control and configuration parameters.

The Trace Session 110 will be stopped with a Trace Session Deactivation 130 which contains at least the Trace Reference of the Trace Session 110.

FIG. 2 is a schematic diagram for illustrating the concepts of Trace Recording Session and Trace Recording Session Reference.

Referring to FIG. 2, the Trace Session 110 may include several Trace Recording Sessions, shown as an example, 2 Trace Recording Sessions 140 and 150. Each of the Trace Recording Sessions 140 and 150 is started with a start trigger (triggering) event and is stopped with a stop trigger (triggering) event. Both the start and stop trigger events are already defined in 3GPP Technical Specifications. In addition, each of the Trace Recording Sessions 140 and 150 is identified by a Trace Recording Session Reference which is unique within the Trace Session 110 including the respective Trace Recording Session.

3GPP Technical Specifications define both management and signaling based trace session activation mechanism.

FIG. 3 is a sequential timing diagram for illustrating an example of tracing Mobile Originating Call with signaling based Trace Session activation in the Circuit Service (CS) domain.

Referring to FIG. 3, in step 301, Element Manager Server (EMS) sends Trace Session Activation to Home Subscriber Server (HSS).

In step 302, when HSS receives Trace Session Activation from the EMS, it stores trace control and configuration parameters associated to the Trace Session.

In step 303, the UE registers to the network, by sending a LOCATION UPDATING REQUEST message to the Mobile Switching Center (MSC) Server (MSS)/Visitor Location Register (VLR).

In step 304, the MSC Server/VLR updates the location information in the HSS by sending the MAP-UPDATE_LOCATION message to the HSS.

In step 305, after receiving the UPDATE_LOCATION message, HSS propagates the trace control and configuration parameters by sending a MAP-ACTIVATE_TRACE_MODE message to the MSC Server/VLR.

In the step 305, when the HSS sends the MAP-ACTIVATE_TRACE_MODE message to the MSC Server, the following parameters are included into the message (herein, “(M)” denotes Mandatory, and “(O)” denotes Optional):
IMSI (M).
Trace reference (M).
Triggering events for MSC Server (M) and MGW (M).
Trace Depth (M).
List of NE types to trace (M).
List of interfaces for MSC Server (O), MGW (O) and/or RNC (O).

In step 306, when the MSC Server/VLR receives the MAP-ACTIVATE_TRACE_MODE message from the HSS, it stores the trace control and configuration parameters.

In step 307, the MSC Server/VLR starts a Trace Session with the Trace Reference received from the HSS.

In steps 308-310, when any of the start triggering event, defined in the trace control and configuration parameters, occurs (e.g. in case of Mobile Originating Call is started (i.e. the MSC Server receives the CM_SERVICE_REQUEST message with service type set to originating call establishment)), the MSC Server starts a Trace Recording Session, and propagates the trace control and configuration parameters to Media GateWay (MGW) (by sending an ADD command with a trace package) and to the radio network if it is defined in the trace control and configuration parameters (Network Element (NE) types to trace).

In the step 310, when the MSC Server sends the ADD command with trace package to MGW, the following parameters are included into the message:
IMSI or IMEI (SV) (M).
Trace reference (M).
Trace Recording Session Reference (M).
Triggering events for MGW (M).
Trace Depth (M).
List of interfaces for MGW (O),

In step 311, after receiving the trace control and configuration parameters from MSC Server, the MGW starts a Trace Session with the Trace Reference received from the MSC Server.

In the current 3GPP technical specification, only subscriber based tracing is defined for Circuit Service (CS) domain. During a call procedure, MSC can propagate the trace control parameters to Radio Network Controller (RNC)/Base Station Controller (BSC) and MGW, but cannot propagate the trace control and configuration parameters from Originating MSC (O-MSC) to Terminated MSC (T-MSC). Due to that limitation:
(1) If the two call parties are not in the same MSC Server, either Mobile Originating (MO) or Mobile Terminated (MT) call procedure can be captured in one trace session depending on MO or MT subscriber Identification (Id) is used for trace session activation.
(2) However, in this situation, the signaling messages traversing Gateway MSC (GMSC)/Transit Switching Center (TSC) for a call procedure cannot be captured.

In practice, the operators often want to trace the End-to-End (E2E) call procedure with both parties' call trace so as to have an E2E view of the call activity and effectively handle trouble shouting. One possibility to tackle the above limitation is to activate one trace session for the calling party at O-MSC and to activate another trace session for the called party at T-MSC. But that's quite inconvenient for the operator, and in most cases the called party is not known in advance.

### SUMMARY OF THE INVENTION

To solve the above problems, a solution is proposed in the present invention to support tracing the End-to-End (E2E) call activity including all the call parties involved in the call procedure.

In the present invention, the trace control and configuration parameters are extended with an E2E call tracing option to indicate whether this Trace Session is an E2E call Trace Session. According to the present invention, if the E2E call tracing option is set, the trace control and configuration parameters are further extended to include a parameter of Trace Collection Entity to indicate a server to which all the trace data shall be sent.

In one preferred embodiment for CS-CS call trace, the signaling between the O-MSC and the TSC/GMSC and the signaling between the GMSC/TSC and the T-MSC are also extended to incorporate a trace extension field including at least the parameters of Trace Reference, Trace Recording Session Reference and Trace Collection Entity.

Alternatively, in another preferred embodiment for CS-CS call trace, the signaling between the O-MSC and the TSC/GMSC, the signaling between the TSC/GMSC and the HLR/HSS, and the signaling between the HLR/HSS and the T-MSC are also extended to incorporate a trace extension field including at least the parameters of Trace Reference, Trace Recording Session Reference and Trace Collection Entity.

In one preferred embodiment for CS-IMS interworking call trace, the signaling between the O-MSC and Media Gateway Control Function (MGCF) and the signaling between the MGCF and Interrogating Call Session Control Function (CSCF) (I-CSCF)/Serving CSCF (S-CSCF) are also extended to incorporate a trace extension field including at least the parameters of Trace Reference, Trace Recording Session Reference and Trace Collection Entity.

Alternatively, in another preferred embodiment for CS-IMS interworking call trace, the signaling between the O-MSC and the S-CSCF and the signaling between the S-CSCF and Service Centralization and Continuity (SCC) Application Server (AS) are also extended to incorporate a trace extension field including at least the parameters of Trace Reference, Trace Recording Session Reference and Trace Collection Entity.

According to a first aspect of the present invention, there is provided a network element acting as an originating network element for end-to-end circuit service call tracing functionality, the network element includes: a receiver configured to receive a trace activation message which contains trace control and configuration parameters, wherein the trace control and configuration parameters include at least a Trace Reference, a start triggering event, a stop triggering event, an end-to-end call tracing option and an address of a Trace Collection Entity; a storage device configured to store the trace control and configuration parameters received by the receiver; a trace data reporter configured to start a trace session with the Trace Reference, to start a Trace Recording Session with a Trace Recording Session Reference when the start triggering event occurs, and to record and output trace data according to the stored trace control and configuration parameters; and a sender configured to detect that the end-to-end call tracing option is included in the trace activation message, and to include/send a trace extension field in a protocol signaling message towards a next Network Element, wherein the trace extension field includes at least the Trace Reference, the Trace Recording Session Reference, and the address of the Trace Collection Entity, wherein the trace data reporter is further configured to stop the Trace Recording Session when the stop triggering event occurs.

Preferably, the trace data reporter is configured to record all the relevant trace data into a trace file, and after stopping the Trace Recording Session, the trace data reporter is configured to output the recorded trace file to the Trace Collection Entity according to the address of the Trace Collection Entity.

Preferably, the trace data reporter is configured to record and output the trace data in a real-time manner to the Trace Collection Entity according to the address of the Trace Collection Entity.

Preferably, the network element is an originating mobile switching center server; the trace activation message is a MAP-ACTIVATE_TRACE_MODE from Home Subscriber Server or a Trace Session Activation from Element Manager Server; and the protocol signaling message is a BICC/ISUP IAM message or an SIP:INVITE message.

According to a second aspect of the present invention, there is provided a network element acting as an intermediate network element for end-to-end circuit service call tracing functionality, the network element includes: a receiver configured to receive a first protocol signaling message which contains a first trace extension field, and the first trace extension field includes at least a Trace Reference, a Trace Recording Session Reference and an address of a Trace Collection Entity; a trace data reporter configured to start a Trace Recording Session with the received Trace Reference and the received Trace Recording Session Reference, and to record and output trace data according to the first trace extension field; and a sender configured to include/send a second trace extension field in a second protocol signaling message towards a next Network Element, wherein the second trace extension field is same as or derived from the first trace extension field, wherein the trace data reporter is further configured to stop the Trace Recording Session when the stop triggering event for the Trace Recording Session occurs.

Preferably, the trace data reporter is configured to record all the relevant trace data into a trace file, and after stopping the Trace Recording Session, the trace data reporter is configured to output the recorded trace file to the Trace Collection Entity according to the address of the Trace Collection Entity.

Preferably, the trace data reporter is configured to record and output the trace data in a real-time manner to the Trace Collection Entity according to the address of the Trace Collection Entity.

Preferably, the network element is a gateway mobile switching center server or a transit switching center; the first protocol signaling message is a BICC/ISUP IAM message; and the second protocol signaling message is a BICC/ISUP IAM message or an MAP SRI message.

Preferably, the network element is a home location register; the first protocol signaling message is an MAP SRI message; and the second protocol signaling message is an MAP PRN message.

Preferably, the network element is a media gateway control function entity; the first protocol signaling message is a BICC/ISUP IAM message; and the second protocol signaling message is an SIP:INVITE message.

Preferably, the network element is a serving call session control function entity, the first protocol signaling message is an SIP:INVITE message; and the second protocol signaling message is an SIP:INVITE message.

According to a third aspect of the present invention, there is provided a network element acting as a terminated network element for end-to-end circuit service call tracing functionality, the network element includes: a receiver configured to receive a protocol signaling message which contains a trace extension field, and the trace extension field includes at least a Trace Reference, a Trace Recording Session Reference and an address of a Trace Collection Entity; and a trace data reporter configured to start a Trace Recording Session with the received Trace Reference and the received Trace Recording Session Reference, to record and output trace data according to the trace extension field, and to stop the Trace Recording Session when the stop triggering event for the Trace Recording Session occurs.

Preferably, the trace data reporter is configured to record all the relevant trace data into a trace file, and after stopping the Trace Recording Session, the trace data reporter is configured to output the recorded trace file to the Trace Collection Entity according to the address of the Trace Collection Entity.

Preferably, the trace data reporter is configured to record and output the trace data in a real-time manner to the Trace Collection Entity according to the address of the Trace Collection Entity.

Preferably, the network element is a terminated mobile switching center server; and the protocol signaling message is a BICC/ISUP IAM message or an MAP PRN message.

Preferably, the network element is a serving call session control function entity; and the protocol signaling message is an SIP:INVITE message.

According to a fourth aspect of the present invention, there is provided a method for providing end-to-end circuit service call tracing functionality, the method comprising steps of: receiving a trace activation message which contains trace control and configuration parameters, wherein the trace control and configuration parameters include at least a Trace Reference, a start triggering event, a stop triggering event, an end-to-end call tracing option and an address of a Trace Collection Entity; storing the received trace control and configuration parameters; starting a trace session with the Trace Reference; starting a Trace Recording Session with a Trace Recording Session Reference when the start triggering event occurs; recording/outputting trace data according to the stored trace control and configuration parameters; including/sending a trace extension field in a protocol signaling message towards a next Network Element, wherein the trace extension field includes at least the Trace Reference, the Trace Recording Session Reference, and the address of the Trace Collection Entity; and stopping the Trace Recording Session when the stop triggering event occurs.

Preferably, all the relevant trace data are recorded into a trace file, and after stopping the Trace Recording Session, the method further comprises a step of outputting the recorded trace file to the Trace Collection Entity according to the address of the Trace Collection Entity.

Preferably, the trace data are recorded and outputted to the Trace Collection Entity according to the address of the Trace Collection Entity in a real-time manner.

Preferably, the method is adopted by an originating mobile switching center server; the trace activation message is a MAP-ACTIVATE_TRACE_MODE from Home Subscriber Server or a Trace Session Activation from Element Manager Server; and the protocol signaling message is a BICC/ISUP IAM message or an SIP:INVITE message.

According to a fifth aspect of the present invention, there is provided a method for providing end-to-end circuit service call tracing functionality, the method comprising steps of: receiving a first protocol signaling message which contains a first trace extension field, and the first trace extension field includes at least a Trace Reference, a Trace Recording Session Reference and an address of a Trace Collection Entity; starting a Trace Recording Session with the received Trace Reference and the received Trace Recording Session Reference; recording/outputting trace data according to the first trace extension field; including/sending a second trace extension field in a second protocol signaling message towards a next Network Element, wherein the second trace extension field is same as or derived from the first trace extension field; and stopping the Trace Recording Session when the stop triggering event for the Trace Recording Session occurs.

Preferably, all the relevant trace data are recorded into a trace file, and after stopping the Trace Recording Session, the method further comprises a step of outputting the recorded trace file to the Trace Collection Entity according to the address of the Trace Collection Entity.

Preferably, the trace data are recorded and outputted to the Trace Collection Entity according to the address of the Trace Collection Entity in a real-time manner.

Preferably, the method is adopted by a gateway mobile switching center server or a transit switching center; the first protocol signaling message is a BICC/ISUP IAM message; and the second protocol signaling message is a BICC/ISUP IAM message or an MAP SRI message.

Preferably, the method is adopted by a home location register; the first protocol signaling message is an MAP SRI message; and the second protocol signaling message is an MAP PRN message.

Preferably, the method is adopted by a media gateway control function entity; the first protocol signaling message is a BICC/ISUP IAM message; and the second protocol signaling message is an SIP:INVITE message.

Preferably, the method is adopted by a serving call session control function entity; the first protocol signaling message is an SIP:INVITE message; and the second protocol signaling message is an SIP:INVITE message.

According to a sixth aspect of the present invention, there is provided a method for providing end-to-end circuit service call tracing functionality, the method comprising steps of: receiving a protocol signaling message which contains a trace extension field, and the trace extension field includes at least a Trace Reference, a Trace Recording Session Reference and an address of a Trace Collection Entity; starting a Trace Recording Session with the received Trace Reference and the received Trace Recording Session Reference; recording/outputting trace data according to the trace extension field; and stopping the Trace Recording Session when the stop triggering event for the Trace Recording Session occurs.

Preferably, all the relevant trace data are recorded into a trace file, and after stopping the Trace Recording Session, the method further comprises a step of outputting the recorded trace file to the Trace Collection Entity according to the address of the Trace Collection Entity.

Preferably, the trace data are recorded and outputted to the Trace Collection Entity according to the address of the Trace Collection Entity in a real-time manner.

Preferably, the method is adopted by a terminated mobile switching center server; and the protocol signaling message is a BICC/ISUP IAM message or an MAP PRN message.

Preferably, the method is adopted by a serving call session control function entity; and the protocol signaling message is an SIP:INVITE message.

### BRIEF DESCRIPTION OF THE DRAWINGS

The above and other objects, features and advantages of the present invention will be clearer from the following detailed description about the non-limited embodiments of the present invention taken in conjunction with the accompanied drawings, in which:

FIG. 1 is a schematic diagram for illustrating the concepts of Trace Session and Trace Reference;

FIG. 2 is a schematic diagram for illustrating the concepts of Trace Recording Session and Trace Recording Session Reference;

FIG. 3 is a sequential timing diagram for illustrating an example of tracing Mobile Originating Call with signaling based Trace Session activation in the Circuit Service (CS) domain;

FIG. 4 is a sequential timing diagram for illustrating a first embodiment of the present invention for an End-to-End (E2E) CS-CS call tracing scenario;

FIG. 5 is a sequential timing diagram for illustrating the second embodiment of the present invention for an E2E CS-CS call tracing scenario;

FIG. 6 is a sequential timing diagram for illustrating the third embodiment of the present invention for an E2E CS-IMS interworking call tracing scenario;

FIG. 7 is a sequential timing diagram for illustrating the fourth embodiment of the present invention for an E2E CS-IMS interworking call tracing scenario;

FIG. 8A is a schematic block diagram to illustrate the structure of a Network Element (NE) 8000 when regarded as the O-MSC in the above first to fourth embodiments;

FIG. 8B is a flowchart to illustrate the operations of an NE 8000 when regarded as the O-MSC in the above first to fourth embodiments;

FIG. 9A is a schematic block diagram to illustrate the structure of an NE 9000 when regarded as the TSC/GMSC in the above first embodiment, as the TSC/GMSC or HSS in the second embodiment, as the MGCF/I-CSCF in the third embodiment, or as the S-CSCF in the fourth embodiment;

FIG. 9B is a flowchart to illustrate the operations of an NE when regarded as the TSC/GMSC in the above first embodiment, as the TSC/GMSC or HSS in the second embodiment, as the MGCF/I-CSCF in the third embodiment, or as the S-CSCF in the fourth embodiment;

FIG. 10A is a schematic block diagram to illustrate the structure of an NE A000 when regarded as the T-MSC in the above first and second embodiments, or as the S-CSCF in the third and fourth embodiments; and

FIG. 10B is a flowchart to illustrate the operations of an NE A000 when regarded as the T-MSC in the above first and second embodiments, or as the S-CSCF in the third and fourth embodiments.

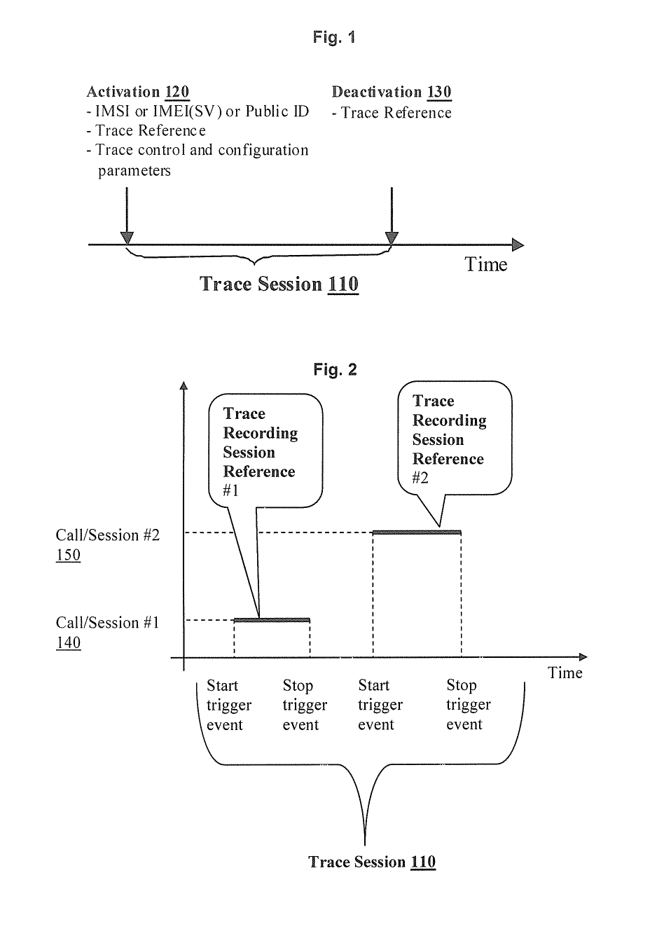

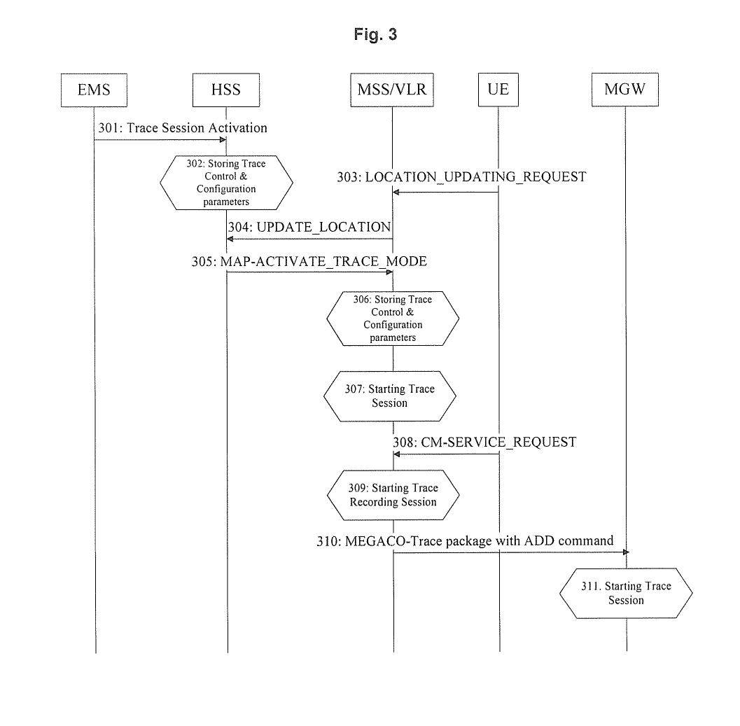

### DETAILED DESCRIPTION OF PREFERRED EMBODIMENTS

Hereunder, the present invention will be described in accordance with the drawings. In the following description, some particular embodiments are used for the purpose of description only, which shall not be understood as any limitation to the present invention but the examples thereof. While it may blur the understanding of the present invention, the conventional structure or construction will be omitted.

### The First Embodiment

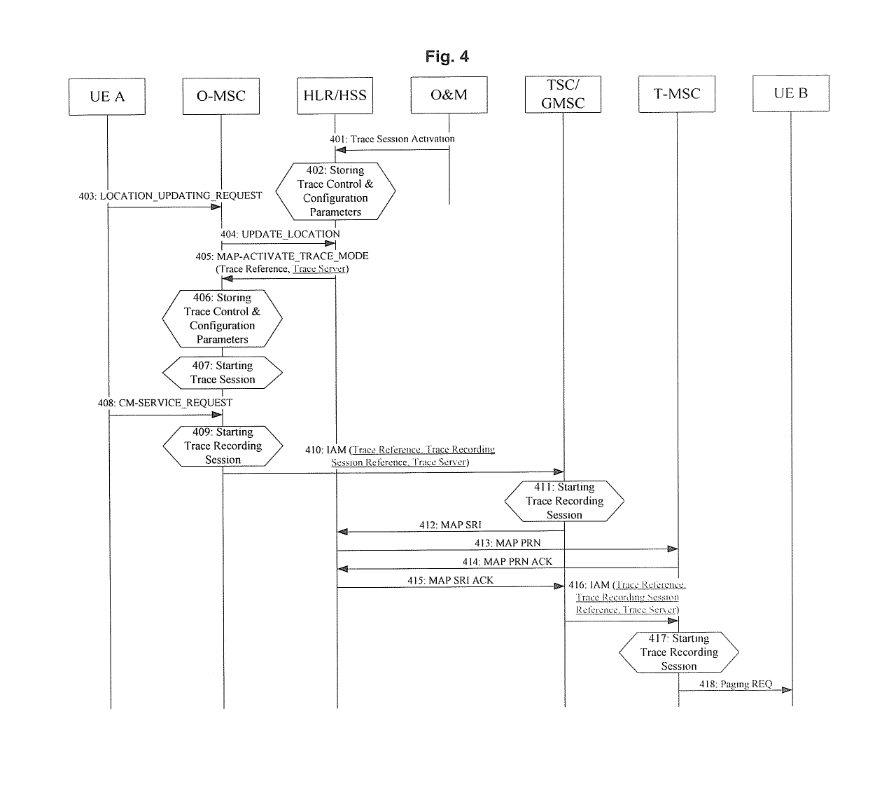

FIG. 4 is a sequential timing diagram for illustrating the first embodiment of the present invention for an End-to-End (E2E) CS-CS call tracing scenario.

Referring to FIG. 4, in step 401, Operation and Maintenance (O&M) Service (such as EMS) sends Trace Session activation to HSS/Home Location Register (HLR).

In the present invention, the trace control and configuration parameters are extended to incorporate an E2E call tracing option to indicate whether this Trace Session is an E2E call Trace Session. If the E2E call tracing option is included (i.e., this Trace Session is an E2E call Trace Session), the trace control and configuration parameters are further extended to include a parameter of Trace Collection Entity to indicate a server to which all the trace data shall be sent. In the context of the present invention, what is described in detail is the case where the E2E call tracing option and the parameter of Trace Collection Entity are included, i.e., the operators instruct to trace the E2E call procedure.

In step 402, when HSS/HLR receives the Trace Session activation from O&M Service, it stores the trace control and configuration parameters associated to the Trace Session, wherein the trace control and configuration parameters include the E2E call tracing option and the parameter of Trace Collection Entity.

In step 403, the UE A registers to the network, by sending a LOCATION UPDATING REQUEST message to the O-MSC Server/VLR.

In step 404, the O-MSC Server/VLR updates the location information in the HSS by sending the MAP-UPDATE_LOCATION message to the HSS.

In step 405, after receiving the UPDATE_LOCATION message, HSS/HLR includes the E2E call tracing option and the parameter of Trace Collection Entity in the trace control and configuration parameters when sending the MAP-ACTIVATE_TRACE_MODE message to the O-MSC Server/VLR.

In the step 405, when the HSS/HLR sends the MAP-ACTIVATE_TRACE_MODE message to the MSC Server, the following parameters are included into the message (herein, “(M)” denotes Mandatory, and “(O)” denotes Optional):
IMSI (M).
Trace reference (M).
E2E Option (O),
Trace Collection Entity (O).
Triggering events for MSC Server (M) and MGW (M).
Trace Depth (M).
List of NE types to trace (M).
List of interfaces for MSC Server (O), MGW (O) and/or RNC (O).

In step 406, when the O-MSC Server/VLR receives the MAP-ACTIVATE_TRACE_MODE message from the HSS, it stores the trace control and configuration parameters (including the E2E call tracing option and the parameter of Trace Collection Entity).

In step 407, the O-MSC Server/VLR starts a Trace Session with the Trace Reference received from the HSS.

In steps 408 and 409, when any of the start triggering event, defined in the trace control and configuration parameters, occurs (e.g. the O-MSC Server receives the CM_SERVICE_REQUEST message with service type set to originating call establishment from UE A), the O-MSC Server starts a Trace Recording Session with a Trace Recording Session Reference, and records and outputs the signaling messages related to the call procedure according to the trace control and configuration parameters.

In step 410, at the start of the trace recording session, the O-MSC includes a trace extension field in outgoing Bearer Independent Call Control (BICC)/ISDN User Part (ISUP) Initial Address Message (IAM) message towards TSC/GMSC if the E2E call tracing option is included (i.e., set) for the corresponding trace session.

As an option, the O-MSC can decide whether to include the trace extension field in the outgoing BICC/ISUP IAM message or not based on the operator policy.

For example, the operator policy may be defined based on calling party number, called party number and/or route category. The detailed determination procedure of the O-MSC for the called party number as an example may be provided as:
analyzing the called party number,
deciding whether or not the called party number belongs to a specific number category predefined by the operators (e.g., is an international one or specific service number),
if the operator policy forbids including the trace extension for the predefined specific number category, not including the trace extension into the outgoing BICC/ISUP IAM message;
otherwise, if the operator policy does not forbids including the trace extension for the predefined specific number category, including the trace extension into the outgoing BICC/ISUP IAM message.

The trace extension field for BICC/ISUP IAM includes at least the following trace control and configuration parameters:
Trace Reference
Trace Recording Session Reference
Triggering events
Trace Depth
List of interfaces
IP address of Trace Collection Entity

The definitions for the above trace control and configuration parameters are the same as those provided in 3GPP Technical Specifications. The “IP address of Trace Collection Entity” is one concrete example of the parameter of Trace Collection Entity, which refers to the common Trace Server where the trace records for the same call procedure received from different network nodes will be correlated based on the Trace Reference and Trace Recording Session Reference.

The compatibility parameter for the trace extension field is set according to BICC/ISUP standard, and will not cause the receiving MSC which not supporting the trace extension to reject the call. According to ITU-Q.1902.2, there is an optional parameter in BICC/ISUP IAM: Parameter compatibility information, this parameter can support adding new parameter in BICC/ISUP IAM message without introducing backward compatible issues.

In step 411, TSC/GMSC starts a Trace Recording Session with the received Trace Reference and Trace Recording Session Reference, if it supports the trace extension field included in BICC/ISUP IAM message, records and outputs the signaling messages related to the call procedure according to the trace control and configuration parameters in the trace extension field included in the received BICC/ISUP IAM message.

Also as an option, the TSC/GMSC can decide whether to start a trace recording session and propagate the trace extension or not based on the operator policy. It shall be noted that the TSC/GMSC may be operated by a different operator from that of the O-MSC, and thus the operator policy may be different from that provided by the operator of the O-MSC (e.g., those listed in the step 410).

In steps 412-415, GMSC sends a Mobile Application Part (MAP) SendRoutingInformation (SRI) message to HSS when interrogating HSS to route the call; the interrogating HSS sends an MAP ProvideRoamingNumber (PRN) message to T-MSC; T-MSC returns an MAP PRN Acknowledgement (ACK) in response to the received MAP PRN from the interrogating HSS; and when receiving the MAP PRN ACK from the T-MSC, the interrogating HSS returns an MAP SRI ACK to the GMSC as an affirmed response to the MAP SRI. This procedure during the steps 412-415 is the same as that provided in 3GPP Technical Specifications.

In step 416, after receiving the MAP SRI ACK from the interrogating HSS, the TSC/GMSC propagates the trace extension field in the outgoing BICC/ISUP IAM message towards T-MSC.

In step 417, the T-MSC starts a Trace Recording Session with the received Trace Reference and Trace Recording Session Reference, if it supports the trace extension field in BICC/ISUP IAM message. After starting the trace recording session, the T-MSC records and outputs the signaling messages related to the call procedure according to the trace control and configuration parameters in the trace extension field included in the received BICC/ISUP IAM message.

Also as an option, the T-MSC can decide whether to start a trace recording session or not based on the operator policy. It shall be noted that the T-MSC may be operated by a different operator from that of the O-MSC and/or that of TSC/GMSC, and thus the operator policy may be different from those respectively provided by the operators of the O-MSC and/or TSC/GMSC (e.g., those listed in the step 410).

In step 418, the T-MSC sends a Paging Request to UE B to which the UE A is calling.

Thereafter, the normal operations for the CS-CS call procedure between the UE A and the UE B are performed among the relevant entities.

During the call procedure, the O-MSC, TSC/GMSC or T-MSC may record (in centralized manner) and output (in real-time manner) the signaling messages related to the call procedure according to the trace control and configuration parameters until the corresponding Trace Recording Session is stopped. The O-MSC, TSC/GMSC or T-MSC removes the trace control and configuration parameters, and stops the trace process at the end of the trace recording session.

In the centralized manner, the O-MSC, TSC/GMSC or T-MSC records all the relevant trace data into a trace file, and after a stop trigger event for the Trace Recording Session occurs, the O-MSC, TSC/GMSC or T-MSC stops the corresponding Trace Recording Session, and then outputs the recorded trace file to the Trace Collection Entity.

In the real-time manner, the O-MSC, TSC/GMSC or T-MSC records and outputs the relevant trace data to the Trace Collection Entity at real-time.

In both the centralized manner and the real-time manner, the Trace Reference and Trace Recording Session Reference are used to correlate the same call procedure and can be included in the name of the recorded trace files (the centralized manner) or in the trace data which is recorded and outputted to the Trace Collection Entity at real-time.

Instead of the operations performed in steps 401-406, another method is to activate the trace session with E2E call tracing capability directly from an Element Manager (EM) entity (such as EMS) to its managed MSC servers. For example, the EMS may directly send the Trace Session Activation to its managed MSC servers without passing through the HSS/HLR, and the managed MSC servers store the trace control and configuration parameters (including the E2E call tracing option and the parameter of Trace Collection Entity). Thereafter, similar to the operation in the step 407, the MSC servers start a Trace Session with the Trace Reference received from the EM entity. The same set of trace control and configuration parameters including the E2E call tracing option as HSS trace activation (referring to the contents described for the step 401) shall be sent to the MSC servers managed by the EM entity via the management interface by using the Trace Session Activation. Compared with the method of trace activation from HSS, management-based activation has no dependency on HSS, but the traced subscriber may not register in the MSC servers of the EM management area. For management-based activation, EM entity need guarantee the uniqueness of the parameter of Trace Reference within its managed area.

Additionally, for both the HSS-based activation described in the steps 401-406 and the aforementioned alternative management-based activation, the operator may also have security concern for management based activation that people who only access a few nodes (one EM area) can get the trace information of the whole network. To relieve the security issue, the operator can configure a list of trustable Trace Collection Entities (i.e., Trace Servers) on MSC servers and prohibit the trace data output to a non-trustable trace server.

In the above description, BICC/ISUP is used as the protocol for Nc interface. The trace control and configuration parameters for E2E call tracing can be also extended to SIP-I based Nc interface (the extension can be included in the BICC/ISUP message encapsulated in the SIP message), or any suitable call control protocol (e.g., TUP) used over the Nc interface. But the extension to the other protocol types shall also ensure the compatibility between sending and receiving nodes. In case the protocol type doesn't provide the compatibility as BICC/ISUP/SIP-I, the trace extension shall be only included when both the receiving and sending nodes support the extension field.

With the above first embodiment of the present invention, the following advantages may be achieved:
(1) Network operators can offer superior customer care service to mobile subscribers. Individual subscribers' problems can be fully traced and localized speeding up problem resolution. This increases customer satisfaction and reduces churn.
(2) The operator can capture the E2E call trace activity by activating a trace session at one network node. It is convenient for the operator to perform trouble shooting and verification of functions.
(3) The solution doesn't cause inter-working issues after introducing the E2E trace option. The MSCs not supporting the E2E tracing capability will ignore the trace extension field and continue the call setup procedure.

### The Second Embodiment

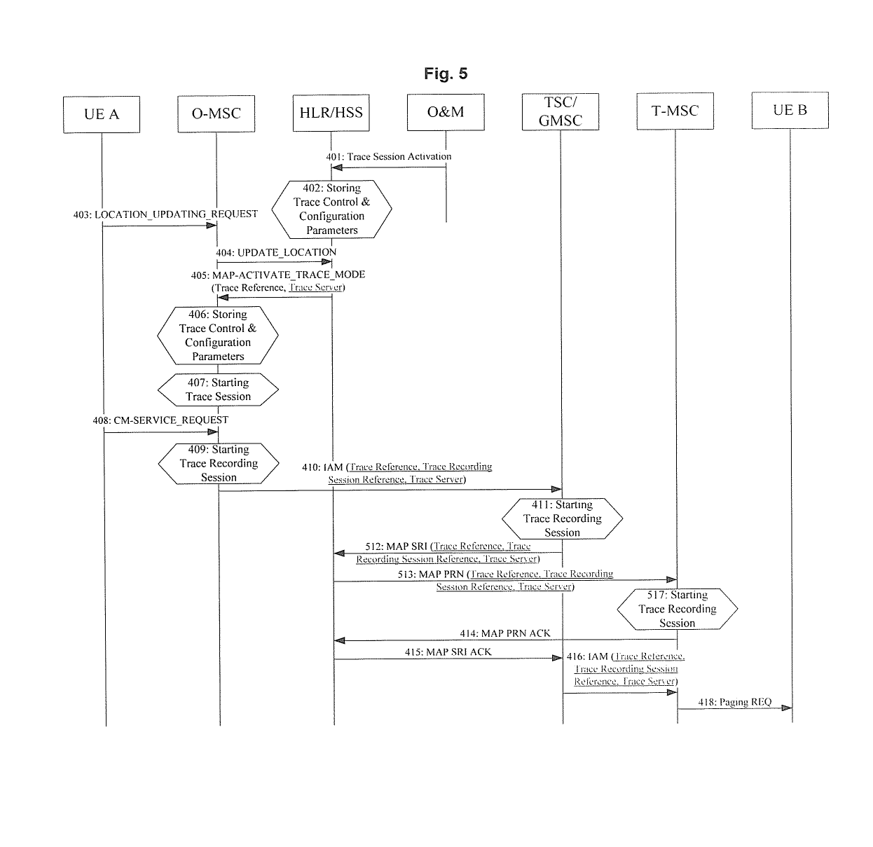

FIG. 5 is a sequential timing diagram for illustrating the second embodiment of the present invention for an End-to-End (E2E) CS-CS call tracing scenario. The steps of FIG. 5 which are the same as FIG. 4 are represented with the same reference numbers and thus the detailed descriptions thereof are omitted for avoiding redundancy.

After the steps 401-411 are performed, in step 512, GMSC includes the extension field of trace control and configuration parameters in the MAP (SRI) message when interrogating HSS to route the call.

In step 513, the interrogating HSS propagates the trace extension field to T-MSC in MAP PRN message if it supports the trace extension.

On the other hand, if the interrogating HSS does not support the trace extension field in the MAP SRI, it will not include the trace extension field in the MAP PRN message, then the steps 413-418 in the first embodiment will be performed instead of the processing sequence of steps 513, 517, 414-416 and 418 in the second embodiment.

In step 517, the T-MSC starts a trace recording session with the received Trace Recording Session Reference, if it detects the trace extension field in the MAP PRN message. After starting the trace recording session, the T-MSC records and outputs the signaling messages related to the call procedure according to the trace control and configuration parameters in the trace extension field included in the received MAP PRN message.

Also as an option, the T-MSC can decide whether to start a trace recording session or not based on the operator policy. It shall be noted that the T-MSC may be operated by a different operator from that of the O-MSC and/or that of TSC/GMSC, and thus the operator policy may be different from those respectively provided by the operators of the O-MSC and/or TSC/GMSC (e.g., those listed in the step 410).

After the steps 414-416 and 418, the normal operations for the CS-CS call procedure between the UE A and the UE B are performed among the relevant entities.

During the call procedure, the O-MSC, TSC/GMSC or T-MSC may record (in centralized manner) and output (in real-time manner) the signaling messages related to the call procedure according to the trace control and configuration parameters until the corresponding Trace Recording Session is stopped. The O-MSC, TSC/GMSC or T-MSC removes the trace control and configuration parameters, and stops the trace process at the end of the trace recording session.

In the centralized manner, the O-MSC, TSC/GMSC or T-MSC records all the relevant trace data into a trace file, and after a stop trigger event for the Trace Recording Session occurs, the O-MSC, TSC/GMSC or T-MSC stops the corresponding Trace Recording Session, and then outputs the recorded trace file to the Trace Collection Entity.

In the real-time manner, the O-MSC, TSC/GMSC or T-MSC records and outputs the relevant trace data to the Trace Collection Entity at real-time.

In both the centralized manner and the real-time manner, the Trace Reference and Trace Recording Session Reference are used to correlate the same call procedure and can be included in the name of the recorded trace files (the centralized manner) or in the trace data which is recorded and outputted to the Trace Collection Entity at real-time.

Instead of the operations performed in steps 401-406, another method is to activate the trace session with E2E call tracing capability directly from an Element Manager (EM) entity (such as EMS) to its managed MSC servers. For example, the EMS may directly send the Trace Session Activation to its managed MSC servers without passing through the HSS/HLR, and the managed MSC servers store the trace control and configuration parameters (including the E2E call tracing option and the parameter of Trace Collection Entity). Thereafter, similar to the operation in the step 407, the MSC servers start a Trace Session with the Trace Reference received from the EM entity. The same set of trace control and configuration parameters including the E2E call tracing option as HSS trace activation (referring to the contents described for the step 401) shall be sent to the MSC servers managed by the EM entity via the management interface by using the Trace Session Activation. Compared with the method of trace activation from HSS, management-based activation has no dependency on HSS, but the traced subscriber may not register in the MSC servers of the EM management area. For management-based activation, EM entity need guarantee the uniqueness of the parameter of Trace Reference within its managed area.

Additionally, for both the HSS-based activation described in the steps 401-406 and the aforementioned alternative management-based activation, the operator may also have security concern for management based activation that people who only access a few nodes (one EM area) can get the trace information of the whole network. To relieve the security issue, the operator can configure a list of trustable Trace Collection Entities (i.e., Trace Servers) on MSC servers and prohibit the trace data output to a non-trustable trace server.

In the above description, BICC/ISUP is used as the protocol for Nc interface. The trace control and configuration parameters for E2E call tracing can be also extended to SIP-I based Nc interface (the extension can be included in the BICC/ISUP message encapsulated in the SIP message), or any suitable call control protocol (e.g., TUP) used over the Nc interface. But the extension to the other protocol types shall also ensure the compatibility between sending and receiving nodes. In case the protocol type doesn't provide the compatibility as BICC/ISUP/SIP-I, the trace extension shall be only included when both the receiving and sending nodes support the extension field.

Although the HLR/HSS is impacted which limits the deployment possibilities, with the above second embodiment of the present invention, the following advantages may be still achieved:
(1) Network operators can offer superior customer care service to mobile subscribers. Individual subscribers' problems can be fully traced and localized speeding up problem resolution. This increases customer satisfaction and reduces churn,
(2) The operator can capture the E2E call trace activity by activating a trace session at one network node. It is convenient for the operator to perform trouble shooting and verification of functions.
(3) The solution doesn't cause inter-working issues after introducing the E2E trace option. The MSCs not supporting the E2E tracing capability will ignore the trace extension field and continue the call setup procedure.

### The Third Embodiment

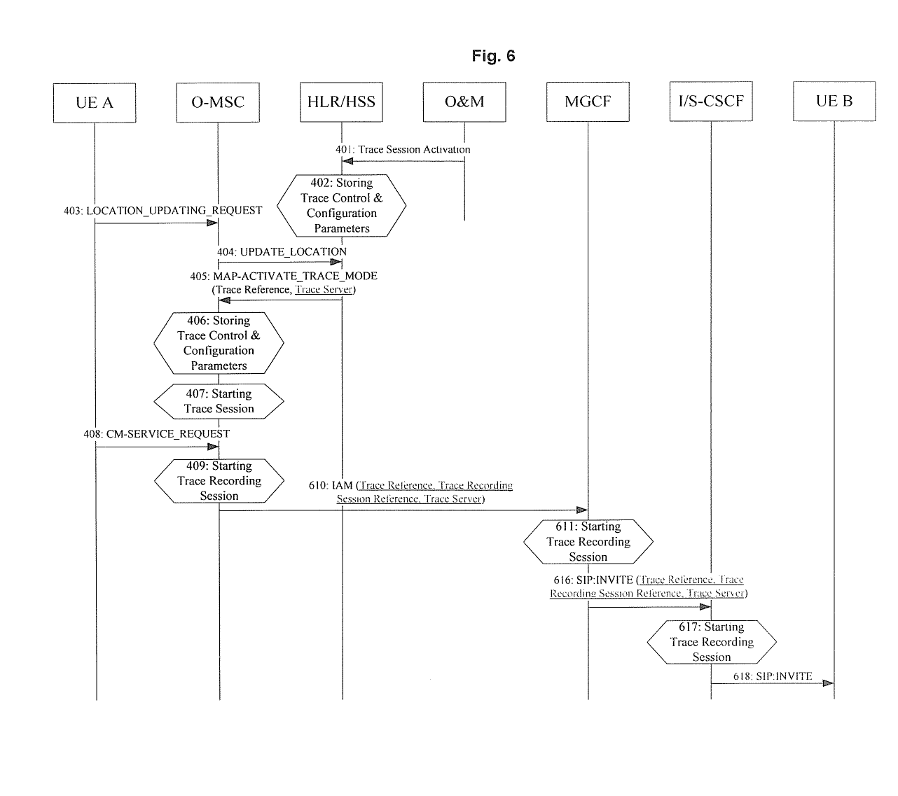

FIG. 6 is a sequential timing diagram for illustrating the third embodiment of the present invention for an End-to-End (E2E) CS-IMS interworking call tracing scenario. The steps of FIG. 6 which are the same as FIG. 4 are represented with the same reference numbers and thus the detailed descriptions thereof are omitted for avoiding redundancy.

After the steps 401-409 are performed, in step 610, for CS-IMS interworking scenario, at the start of the trace recording session, the O-MSC includes a trace extension field in outgoing BICC/ISUP IAM message towards Media Gateway Control Function (MGCF) if the E2E call tracing option is included (i.e., set) for the corresponding trace session.

As an option, the O-MSC can decide whether to include the trace extension field in the outgoing BICC/ISUP IAM message or not based on the operator policy.

For example, the operator policy may be defined based on calling party number, called party number and/or route category. The detailed determination procedure of the O-MSC for the called party number as an example may be provided as:
analyzing the called party number,
deciding whether or not the called party number belongs to a specific number category predefined by the operators (e.g., is an international one or specific service number),
if the operator policy forbids including the trace extension for the predefined specific number category, not including the trace extension into the outgoing BICC/ISUP IAM message;
otherwise, if the operator policy does not forbids including the trace extension for the predefined specific number category, including the trace extension into the outgoing BICC/ISUP IAM message.

The trace extension field for BICC/ISUP IAM includes at least the following trace control and configuration parameters:
Trace Reference
Trace Recording Session Reference
Triggering events
Trace Depth
List of interfaces
IP address of Trace Collection Entity

The definitions for the above trace control and configuration parameters are the same as those provided in 3GPP Technical Specifications. The “IP address of Trace Collection Entity” is one concrete example of the parameter of Trace Collection Entity, which refers to the common Trace Server where the trace records for the same call procedure received from different network nodes will be correlated based on the Trace Reference and Trace Recording Session Reference.

The compatibility parameter for the trace extension field is set according to BICC/ISUP standard, and will not cause the receiving MSC which not supporting the trace extension to reject the call. According to ITU-Q.1902.2, there is an optional parameter in BICC/ISUP IAM: Parameter compatibility information, this parameter can support adding new parameter in BICC/ISUP IAM message without introducing backward compatible issues.

In step 611, MGCF starts a Trace Recording Session with the received Trace Reference and Trace Recording Session Reference, if it supports the trace extension field included in BICC/ISUP IAM message, records and outputs the outgoing Session Initiation Protocol (SIP) signaling messages related to the call procedure according to the trace control and configuration parameters in the trace extension field included in the received BICC/ISUP IAM message.

Also as an option, the MGCF can decide whether to start a trace recording session and propagate the trace control and configuration parameters or not based on the operator policy. It shall be noted that the MGCF may be operated by a different operator from that of the O-MSC, and thus the operator policy may be different from that provided by the operator of the O-MSC (e.g., those listed in the step 610).

In step 616, the MGCF propagates the trace control and configuration parameters in outgoing SIP INVITE message towards Interrogating Call Session Control Function (CSCF) (I-CSCF)/Serving CSCF (S-CSCF) based on the operator policy.

In step 617, the I/S-CSCF starts a Trace Recording Session with the received Trace Reference and Trace Recording Session Reference. After starting the trace recording session, the I/S-CSCF records and outputs the SIP signaling messages related to the call procedure according to the trace control and configuration parameters included in the received SIP INVITE message.

Also as an option, the I/S-CSCF can decide whether to start a trace recording session or not based on the operator policy. It shall be noted that the I/S-CSCF may be operated by a different operator from that of the O-MSC and/or that of MGCF, and thus the operator policy may be different from those respectively provided by the operators of the O-MSC and/or MGCF (e.g., those listed in the step 610).

In step 618, the S-CSCF sends an SIP INVITE message to UE B to which the UE A is calling.

Thereafter, the normal operations for the CS-IMS interworking call procedure between the UE A and the UE B are performed among the relevant entities.

During the call procedure, the O-MSC, MGCF or I/S-CSCF may record (in centralized manner) and output (in real-time manner) the signaling messages related to the call procedure according to the trace control and configuration parameters until the corresponding Trace Recording Session is stopped. The O-MSC, MGCF or I/S-CSCF removes the trace control and configuration parameters, and stops the trace process at the end of the trace recording session.

In the centralized manner, the O-MSC, MGCF or I/S-CSCF records all the relevant trace data into a trace file, and after a stop trigger event for the Trace Recording Session occurs, the O-MSC, MGCF or I/S-CSCF stops the corresponding Trace Recording Session, and then outputs the recorded trace file to the Trace Collection Entity.

In the real-time manner, the O-MSC, MGCF or I/S-CSCF records and outputs the relevant trace data to the Trace Collection Entity at real-time.

In both the centralized manner and the real-time manner, the Trace Reference and Trace Recording Session Reference are used to correlate the same call procedure and can be included in the name of the recorded trace files (the centralized manner) or in the trace data which is recorded and outputted to the Trace Collection Entity at real-time.

Instead of the operations performed in steps 401-406, another method is to activate the trace session with E2E call tracing capability directly from an Element Manager (EM) entity (such as EMS) to its managed MSC servers. For example, the EMS may directly send the Trace Session Activation to its managed MSC servers without passing through the HSS/HLR, and the managed MSC servers store the trace control and configuration parameters (including the E2E call tracing option and the parameter of Trace Collection Entity). Thereafter, similar to the operation in the step 407, the MSC servers start a Trace Session with the Trace Reference received from the EM entity. The same set of trace control and configuration parameters including the E2E call tracing option as HSS trace activation (referring to the contents described for the step 401) shall be sent to the MSC servers managed by the EM entity via the management interface by using the Trace Session Activation. Compared with the method of trace activation from HSS, management-based activation has no dependency on HSS, but the traced subscriber may not register in the MSC servers of the EM management area. For management-based activation. EM entity need guarantee the uniqueness of the parameter of Trace Reference within its managed area.

Additionally, for both the HSS-based activation described in the steps 401-406 and the aforementioned alternative management-based activation, the operator may also have security concern for management based activation that people who only access a few nodes (one EM area) can get the trace information of the whole network. To relieve the security issue, the operator can configure a list of trustable Trace Collection Entities (i.e., Trace Servers) on MSC servers and prohibit the trace data output to a non-trustable trace server.

With the above third embodiment of the present invention, the following advantages may be achieved:
(1) Network operators can offer superior customer care service to mobile subscribers. Individual subscribers' problems can be fully traced and localized speeding up problem resolution. This increases customer satisfaction and reduces churn.
(2) The operator can capture the E2E call trace activity by activating a trace session at one network node. It is convenient for the operator to perform trouble shooting and verification of functions.
(3) The solution doesn't cause inter-working issues after introducing the E2E trace option. The MSCs not supporting the E2E tracing capability will ignore the trace extension field and continue the call setup procedure.

### The Fourth Embodiment

FIG. 7 is a sequential timing diagram for illustrating the fourth embodiment of the present invention for an End-to-End (E2E) CS-IMS interworking call tracing scenario. The steps of FIG. 7 which are the same as FIG. 4 are represented with the same reference numbers and thus the detailed descriptions thereof are omitted for avoiding redundancy.

In the fourth embodiment of the present invention, the O-MSC is enhanced for IMS Centralized Service (ICS) so as to be deployed in the ICS based CS-IMS interworking scenario.

After the steps 401-409 are performed, in step 710, at the start of the trace recording session, the O-MSC includes the trace control and configuration parameters in outgoing SIP INVITE message towards S-CSCF if the E2E call tracing option is included (i.e., set) for the corresponding trace session.

As an option, the O-MSC can decide whether to include the trace control and configuration parameters in the outgoing SIP INVITE message or not based on the operator policy.

For example, the operator policy may be defined based on calling party number, called party number and/or route category. The detailed determination procedure of the O-MSC for the called party number as an example may be provided as:
analyzing the called party number,
deciding whether or not the called party number belongs to a specific number category predefined by the operators (e.g., is an international one or specific service number),
if the operator policy forbids including the trace control and configuration parameters for the predefined specific number category, not including the trace control and configuration parameters into the outgoing SIP INVITE message;
otherwise, if the operator policy does not forbids including the trace control and configuration parameters for the predefined specific number category, including the trace control and configuration parameters into the outgoing SIP INVITE message.

The trace control and configuration parameters for SIP INVITE message include at least the following items:
Trace Reference
Trace Recording Session Reference
Triggering events
Trace Depth
List of interfaces
IP address of Trace Collection Entity

The definitions for the above trace control and configuration parameters are the same as those provided in 3GPP Technical Specifications. The IF address of Trace Collection Entity” is one concrete example of the parameter of Trace Collection Entity, which refers to the common Trace Server where the trace records for the same call procedure received from different network nodes will be correlated based on the Trace Reference and Trace Recording Session Reference

In step 711, S-CSCF starts a Trace Recording Session with the received Trace Reference and Trace Recording Session Reference, if it supports the trace control and configuration parameters included in SIP INVITE message, records and outputs the outgoing SIP signaling messages related to the call procedure according to the trace control and configuration parameters included in the received SIP INVITE message.

Also as an option, the S-CSCF can decide whether to start a trace recording session and propagate the trace control and configuration parameters or not based on the operator policy. It shall be noted that the S-CSCF may be operated by a different operator from that of the O-MSC, and thus the operator policy may be different from that provided by the operator of the O-MSC (e.g., those listed in the step 710).

In step 716, the S-CSCF propagates the trace control and configuration parameters in outgoing SIP INVITE message towards Service Centralization and Continuity (SCC) Application Server (AS) based on the operator policy.

In step 717, the SCC AS starts a Trace Recording Session with the received Trace Reference and Trace Recording Session Reference. After starting the trace recording session, the SCC AS records and outputs the SIP signaling messages related to the call procedure according to the trace control and configuration parameters included in the received SIP INVITE message.

Also as an option, the SCC AS can decide whether to start a trace recording session or not based on the operator policy. It shall be noted that the SCC AS may be operated by a different operator from that of the O-MSC and/or that of S-CSCF, and thus the operator policy may be different from those respectively provided by the operators of the O-MSC and/or S-CSCF (e.g., those listed in the step 710).

In step 720, the SCC AS sends an SIP INVITE message to the S-CSCF as a response to the SIP INVITE message received from the S-CSCF.

In step 618, the S-CSCF sends an SIP INVITE message to UE B to which the UE A is calling.

Thereafter, the normal operations for the CS-IMS interworking call procedure between the UE A and the UE B are performed among the relevant entities.

During the call procedure, the O-MSC, S-CSCF or SCC AS may record (in centralized manner) and output (in real-time manner) the signaling messages related to the call procedure according to the trace control and configuration parameters until the corresponding Trace Recording Session is stopped. The O-MSC, S-CSCF or SCC AS removes the trace control and configuration parameters, and stops the trace process at the end of the trace recording session.

In the centralized manner, the O-MSC, S-CSCF or SCC AS records all the relevant trace data into a trace file, and after a stop trigger event for the Trace Recording Session occurs, the O-MSC, S-CSCF or SCC AS stops the corresponding Trace Recording Session, and then outputs the recorded trace file to the Trace Collection Entity.

In the real-time manner, the O-MSC, S-CSCF or SCC AS records and outputs the relevant trace data to the Trace Collection Entity at real-time.

In both the centralized manner and the real-time manner, the Trace Reference and Trace Recording Session Reference are used to correlate the same call procedure and can be included in the name of the recorded trace files (the centralized manner) or in the trace data which is recorded and outputted to the Trace Collection Entity at real-time.

Instead of the operations performed in steps 401-406, another method is to activate the trace session with E2E call tracing capability directly from an Element Manager (EM) entity (such as EMS) to its managed MSC servers. For example, the EMS may directly send the Trace Session Activation to its managed MSC servers without passing through the HSS/HLR, and the managed MSC servers store the trace control and configuration parameters (including the E2E call tracing option and the parameter of Trace Collection Entity). Thereafter, similar to the operation in the step 407, the MSC servers start a Trace Session with the Trace Reference received from the EM entity. The same set of trace control and configuration parameters including the E2E call tracing option as HSS trace activation (referring to the contents described for the step 401) shall be sent to the MSC servers managed by the EM entity via the management interface by using the Trace Session Activation. Compared with the method of trace activation from HSS, management-based activation has no dependency on HSS, but the traced subscriber may not register in the MSC servers of the EM management area. For management-based activation, EM entity need guarantee the uniqueness of the parameter of Trace Reference within its managed area.

Additionally, for both the HSS-based activation described in the steps 401-406 and the aforementioned alternative management-based activation, the operator may also have security concern for management based activation that people who only access a few nodes (one EM area) can get the trace information of the whole network. To relieve the security issue, the operator can configure a list of trustable Trace Collection Entities (i.e., Trace Servers) on MSC servers and prohibit the trace data output to a non-trustable trace server.

Although the O-MSC is enhanced for ICS which increases the system deployment complexity, with the above fourth embodiment of the present invention, the following advantages may be achieved:
(1) Network operators can offer superior customer care service to mobile subscribers. Individual subscribers' problems can be fully traced and localized speeding up problem resolution. This increases customer satisfaction and reduces churn,
(2) The operator can capture the E2E call trace activity by activating a trace session at one network node. It is convenient for the operator to perform trouble shooting and verification of functions.
(3) The solution doesn't cause inter-working issues after introducing the E2E trace option. The MSCs not supporting the E2E tracing capability will ignore the trace extension field and continue the call setup procedure.

[Structures and Operations of Relevant Network Elements]

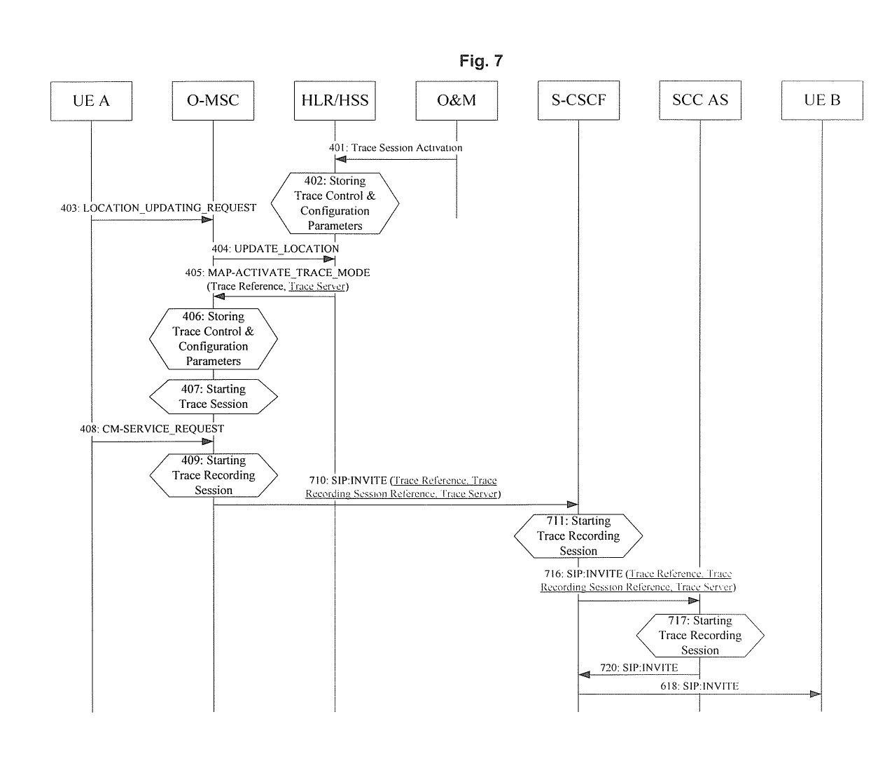

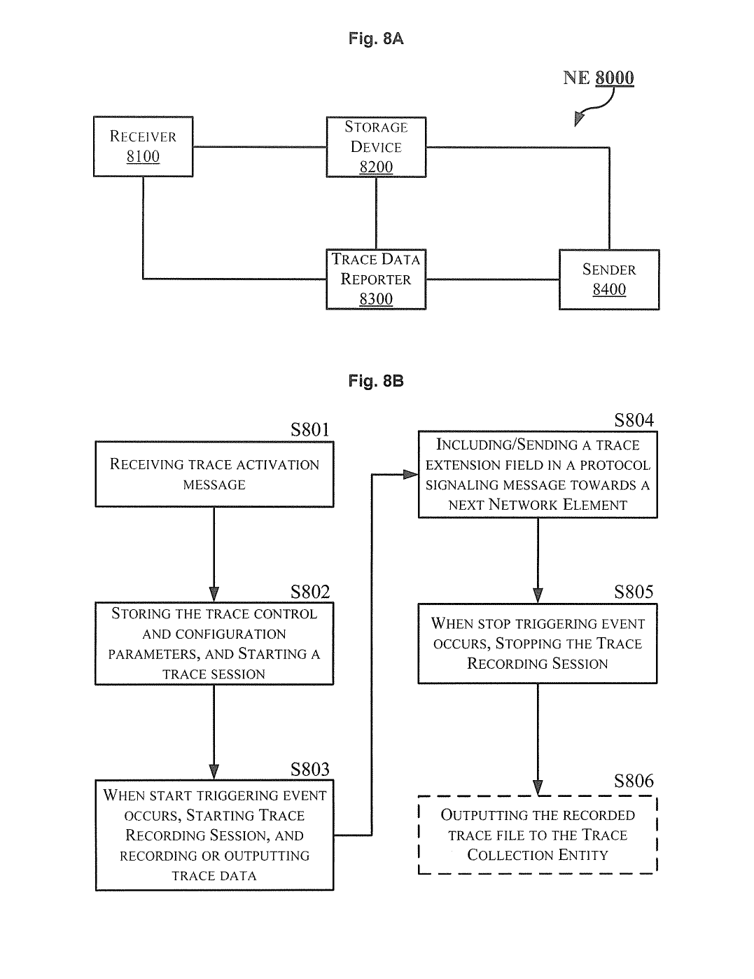

FIG. 8A is a schematic block diagram to illustrate the structure of a Network Element (NE) 8000 when regarded as the O-MSC in the above first to fourth embodiments; and FIG. 8B is a flowchart to illustrate the operations of a Network Element (NE) 8000 when regarded as the O-MSC in the above first to fourth embodiments.

Referring to FIG. 8A, the NE 8000 includes a receiver 8100, a storage device 8200, a trace data reporter 8300 and a sender 8400.

Next, the operations of the respective units of the NE 8000 will be described in reference to FIG. 88.

In step S801, the receiver 8100 of the NE 8000 receives a trace activation message which contains trace control and configuration parameters, and the trace control and configuration parameters include at least a Trace Reference, a start triggering event, a stop triggering event, an E2E call tracing option and an address of a Trace Collection Entity.

In step S802, the storage device 8200 of the NE 8000 stores the trace control and configuration parameters and the trace data reporter 8300 of the NE 8000 starts a trace session with the Trace Reference.

In step S803, when the start triggering event occurs, the trace data reporter 8300 of the NE 8000 starts a Trace Recording Session with a Trace Recording Session Reference, and the trace data reporter 8300 of the NE 8000 records and outputs trace data according to the trace control and configuration parameters.

In step S804, the sender 8400 of the NE 8000 detects that the E2E call tracing option is included in the trace activation message, and includes/sends a trace extension field in a protocol signaling message towards a next Network Element, wherein the trace extension field includes at least the Trace Reference, the Trace Recording Session Reference, and the address of the Trace Collection Entity.

As an option, the sender 8400 of the NE 8000 may decide whether to include the trace extension field in the protocol signaling message or not based on its operator policy, e.g. those listed in the step 410 of the first embodiment.

The trace data reporter 8300 of the NE 8000 records and outputs the trace data according to the Trace Recording Session until the stop triggering event occurs.

In step S805, when the stop triggering event occurs, the trace data reporter 8300 of the NE 8000 stops the Trace Recording Session.

On one hand, the trace data reporter 8300 of the NE 8000 records all the relevant trace data into a trace file, and after stopping the Trace Recording Session, in step S806 (optional), the trace data reporter 8300 of the NE 8000 outputs the recorded trace file to the Trace Collection Entity according to the address of the Trace Collection Entity.

On the other hand, the trace data reporter 8300 of the NE 8000 records and outputs the trace data in a real-time manner to the Trace Collection Entity according to the address of the Trace Collection Entity. In this case, the optional step S806 is not necessary.

In this scenario, the trace activation message may be the MAP-ACTIVATE_TRACE_MODE from the HSS or Trace Session Activation from EMS in the first to fourth embodiments; and the protocol signaling message may be the BICC/ISUP IAM message in the first to third embodiments or the SIP:INVITE message in the fourth embodiment.

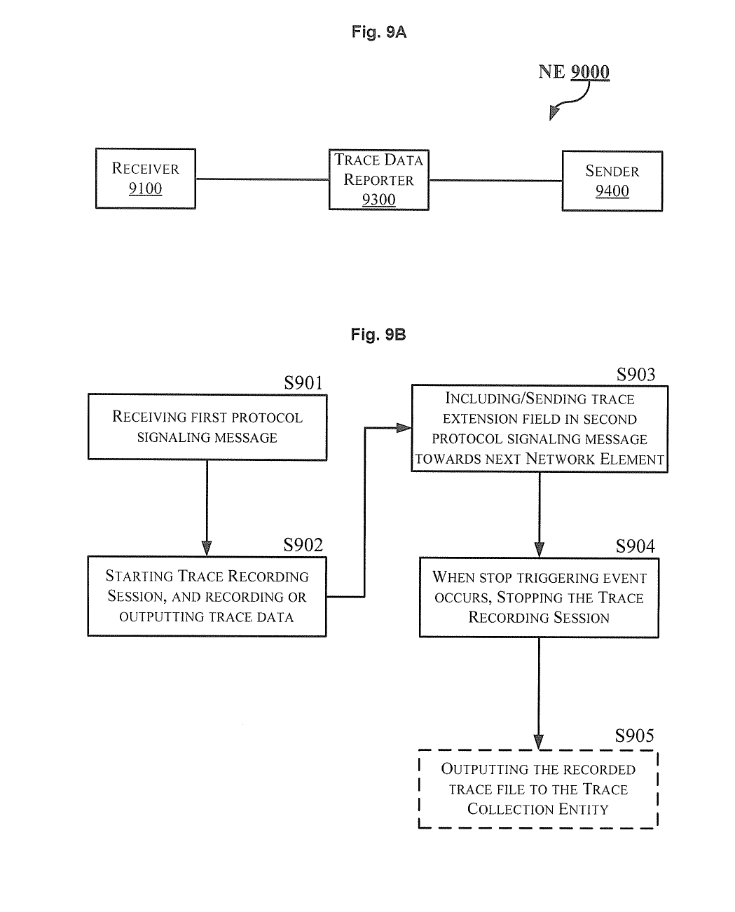

FIG. 9A is a schematic block diagram to illustrate the structure of a Network Element (NE) 9000 when regarded as the TSC/GMSC in the above first embodiment, as the TSC/GMSC or HSS in the second embodiment, as the MGCF/I-CSCF in the third embodiment, or as the S-CSCF in the fourth embodiment; and FIG. 9B is a flowchart to illustrate the operations of a Network Element (NE) when regarded as the TSC/GMSC in the above first embodiment, as the TSC/GMSC or HSS in the second embodiment, as the MGCF/I-CSCF in the third embodiment, or as the S-CSCF in the fourth embodiment.

Referring to FIG. 9A, the NE 9000 includes a receiver 9100, a trace data reporter 9300 and a sender 9400.

Next, the operations of the respective units of the NE 9000 will be described in reference to FIG. 9B,

In step S901, the receiver 9100 of the NE 9000 receives a first protocol signaling message which contains a first trace extension field, and the first trace extension field includes at least a Trace Reference, a Trace Recording Session Reference and an address of a Trace Collection Entity.

In step S902, the trace data reporter 9300 of the NE 9000 starts a Trace Recording Session with the Trace Reference and the Trace Recording Session Reference, and the trace data reporter 9300 of the NE 9000 records and outputs trace data according to the first trace extension field.

In step S903, the sender 9400 of the NE 9000 includes/sends a second trace extension field in a second protocol signaling message towards a next Network Element, wherein the second trace extension field is same as or derived from the first trace extension field.

As an option, the sender 9400 of the NE 9000 may decide whether to include the second trace extension field in the second protocol signaling message or not based on its operator policy, e.g. those listed in the step 410 of the first embodiment.

The trace data reporter 9300 of the NE 9000 records and outputs the trace data according to the Trace Recording Session until a stop triggering event for the Trace Recording Session occurs.

In step S904, when the stop triggering event for the Trace Recording Session occurs, trace data reporter 9300 of the NE 9000 stops the Trace Recording Session.

On one hand, the trace data reporter 9300 of the NE 9000 records all the relevant trace data into a trace file, and after stopping the Trace Recording Session, in step S905 (optional), the trace data reporter 9300 of the NE 9000 outputs the recorded trace file to the Trace Collection Entity according to the address of the Trace Collection Entity.

On the other hand, the trace data reporter 9300 of the NE 9000 records and outputs the trace data in a real-time manner to the Trace Collection Entity according to the address of the Trace Collection Entity. In this case, the optional step S905 is not necessary.

In this scenario, the first protocol signaling message may be the BICC/ISUP IAM message in the first and third embodiments, the BICC/ISUP IAM message (for TSC/GMSC) or the MAP SRI message (for HSS) in the second embodiment, or the SIP:INVITE message in the fourth embodiment; and the second protocol signaling message may be the BICC/ISUP IAM message in the first embodiment, the MAP SRI message (for GMSC) or the MAP PRN message (for HSS) or the BICC/ISUP IAM message (for TSC/GMSC) in the second embodiment, or the SIP:INVITE message in the third and fourth embodiments.

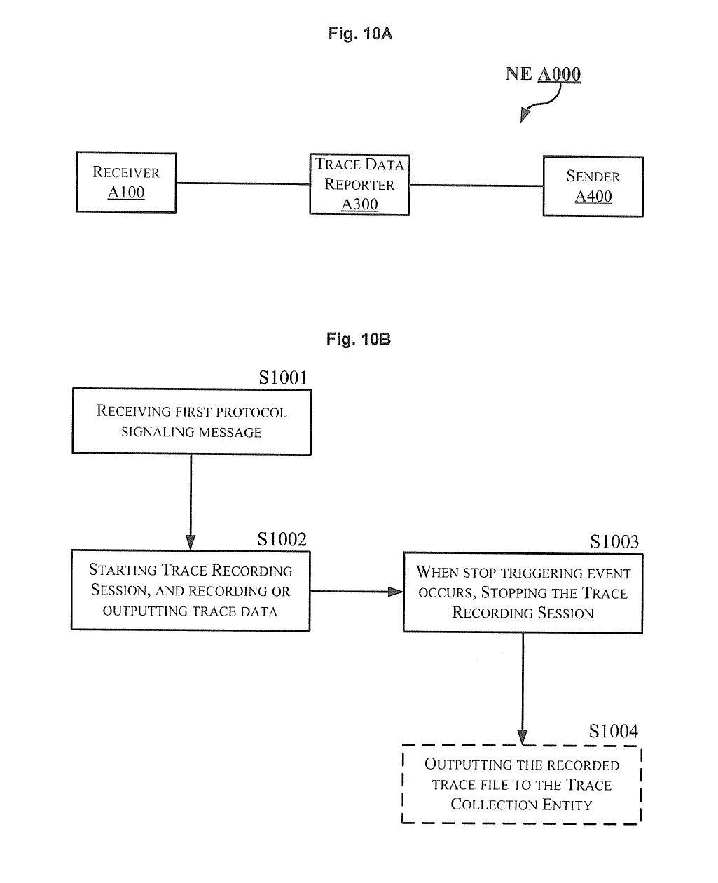

FIG. 10A is a schematic block diagram to illustrate the structure of a Network Element (NE) A000 when regarded as the T-MSC in the above first and second embodiments, or as the S-CSCF in the third and fourth embodiments; and FIG. 10B is a flowchart to illustrate the operations of a Network Element (NE) A000 when regarded as the T-MSC in the above first and second embodiments, or as the S-CSCF in the third and fourth embodiments,

Referring to FIG. 10A, the NE A000 includes a receiver A100, a trace data reporter A300 and a sender A400.

Next, the operations of the respective units of the NE A000 will be described in reference to FIG. 10B.

In step S1001, the receiver A100 of the NE A000 receives a protocol signaling message which contains a trace extension field, and the trace extension field includes at least a Trace Reference, a Trace Recording Session Reference and an address of a Trace Collection Entity.

In step S1002, the trace data reporter A300 of the NE A000 starts a Trace Recording Session with the Trace Reference and the Trace Recording Session Reference, and the trace data reporter A300 of the NE A000 records and outputs trace data according to the trace extension field.

The trace data reporter A300 of the NE A000 records and outputs the trace data according to the Trace Recording Session until a stop triggering event for the Trace Recording Session occurs.

In step S1003, when the stop triggering event for the Trace Recording Session occurs, the trace data reporter A300 of the NE A000 stops the Trace Recording Session.

On one hand, the trace data reporter A300 of the NE A000 records all the relevant trace data into a trace file, and after stopping the Trace Recording Session, in step S1004 (optional), the trace data reporter A300 of the NE A000 outputs the recorded trace file to the Trace Collection Entity according to the address of the Trace Collection Entity.

On the other hand, the trace data reporter A300 of the NE A000 records and outputs the trace data in a real-time manner to the Trace Collection Entity according to the address of the Trace Collection Entity. In this case, the optional step S1004 is not necessary.

In this scenario, the protocol signaling message may be the BICC/ISUP IAM message in the first embodiment, the MAP PRN message or the BICC/ISUP IAM message in the second embodiment, or the SIP:INVITE message in the third and fourth embodiments.

The foregoing description gives only the preferred embodiments of the present invention and is not intended to limit the present invention in any way. Thus, any modification, substitution, improvement or like made within the spirit and principle of the present invention should be encompassed by the scope of the present invention.

1-32. (canceled)

33. A network element acting as an originating network element for end-to-end circuit service call tracing functionality, the network element comprising:
a receiver configured to receive a trace activation message which contains trace control and configuration parameters, wherein the trace control and configuration parameters include at least:
a Trace Reference;
a start triggering event;
a stop triggering event;
an end-to-end call tracing option; and
an address of a Trace Collection Entity;
a storage device configured to store the trace control and configuration parameters received by the receiver;
a trace data reporter configured to:
start a trace session with the Trace Reference;
start a Trace Recording Session with a Trace Recording Session Reference when the start triggering event occurs; and
record and output trace data according to the stored trace control and configuration parameters;
a sender configured to:
detect that the end-to-end call tracing option is included in the trace activation message;
send a trace extension field in a protocol signaling message towards a next Network Element, wherein the trace extension field includes at least the Trace Reference, the Trace Recording Session Reference, and the address of the Trace Collection Entity;
wherein the trace data reporter is further configured to stop the Trace Recording Session when the stop triggering event occurs.

34. The network element of claim 33, wherein the trace data reporter is configured to:
record the relevant trace data into a trace file; and
after stopping the Trace Recording Session, output the recorded trace file to the Trace Collection Entity according to the address of the Trace Collection Entity.

35. The network element of claim 33, wherein the trace data reporter is configured to record and output the trace data in a real-time manner to the Trace Collection Entity according to the address of the Trace Collection Entity.

36. The network element of claim 33, wherein:
the network element is an originating mobile switching center server;
the trace activation message is a MAP-ACTIVATE_TRACE_MODE from a Home Subscriber Server or a Trace Session Activation from an Element Manager Server; and
the protocol signaling message is a BICC/ISUP IAM message or an SIP:INVITE message.

37. A network element acting as an intermediate network element for end-to-end circuit service call tracing functionality, the network element comprising:
a receiver configured to receive a first protocol signaling message which contains a first trace extension field, wherein the first trace extension field includes at least:
a Trace Reference;
a Trace Recording Session Reference; and
an address of a Trace Collection Entity;
a trace data reporter configured to:
start a Trace Recording Session with the received Trace Reference and the received Trace Recording Session Reference; and
record and output trace data according to the first trace extension field;
a sender configured to send a second trace extension field in a second protocol signaling message towards a next Network Element, wherein the second trace extension field is same as or derived from the first trace extension field;
wherein the trace data reporter is further configured to stop the Trace Recording Session when the stop triggering event for the Trace Recording Session occurs.

38. The network element of claim 37, wherein the trace data reporter is configured to:
record the relevant trace data into a trace file; and
after stopping the Trace Recording Session, output the recorded trace file to the Trace Collection Entity according to the address of the Trace Collection Entity.

39. The network element of claim 37, wherein the trace data reporter is configured to record and output the trace data in a real-time manner to the Trace Collection Entity according to the address of the Trace Collection Entity.

40. The network element of claim 37, wherein:
the network element is a gateway mobile switching center server or a transit switching center;
the first protocol signaling message is a BICC/ISUP IAM message; and
the second protocol signaling message is a BICC/ISUP IAM message or an MAP SRI message.

41. The network element of claim 37, wherein:
the network element is a home location register;
the first protocol signaling message is an MAP SRI message; and
the second protocol signaling message is an MAP PRN message.

42. The network element of claim 37, wherein:
the network element is a media gateway control function entity;
the first protocol signaling message is a BICC/ISUP IAM message; and
the second protocol signaling message is an SIP:INVITE message.

43. The network element of claim 37, wherein:
the network element is a serving call session control function entity;
the first protocol signaling message is an SIP:INVITE message; and
the second protocol signaling message is an SIP:INVITE message.

44. A network element acting as a terminated network element for end-to-end circuit service call tracing functionality, the network element comprising:
a receiver configured to receive a protocol signaling message which contains a trace extension field, wherein the trace extension field includes at least:
a Trace Reference;
a Trace Recording Session Reference; and
an address of a Trace Collection Entity;
a trace data reporter configured to:
start a Trace Recording Session with the received Trace Reference and the received Trace Recording Session Reference;
record and output trace data according to the trace extension field; and
stop the Trace Recording Session when the stop triggering event for the Trace Recording Session occurs.

45. The network element of claim 44, wherein the trace data reporter is configured to:
record the relevant trace data into a trace file; and
after stopping the Trace Recording Session, output the recorded trace file to the Trace Collection Entity according to the address of the Trace Collection Entity.

46. The network element of claim 44, wherein the trace data reporter is configured to record and output the trace data in a real-time manner to the Trace Collection Entity according to the address of the Trace Collection Entity.

47. The network element of claim 44, wherein:
the network element is a terminated mobile switching center server; and
the protocol signaling message is a BICC/ISUP IAM message or an MAP PRN message.

48. The network element of claim 44, wherein:
the network element is a serving call session control function entity; and
the protocol signaling message is an SIP:INVITE message.

49. A method for providing end-to-end circuit service call tracing functionality, the method comprising:
receiving a trace activation message which contains trace control and configuration parameters, wherein the trace control and configuration parameters include at least:
a Trace Reference;
a start triggering event;
a stop triggering event;
an end-to-end call tracing option; and
an address of a Trace Collection Entity;
storing the received trace control and configuration parameters;
starting a trace session with the Trace Reference;
starting a Trace Recording Session with a Trace Recording Session Reference when the start triggering event occurs;
recording and outputting trace data according to the stored trace control and configuration parameters;
sending a trace extension field in a protocol signaling message towards a next Network Element, wherein the trace extension field includes at least the Trace Reference, the Trace Recording Session Reference, and the address of the Trace Collection Entity; and
stopping the Trace Recording Session when the stop triggering event occurs.

50. The method of claim 49, wherein:
the recording the trace data comprises recording the relevant trace data into a trace file;
the method further comprises, after stopping the Trace Recording Session, outputting the recorded trace file to the Trace Collection Entity according to the address of the Trace Collection Entity.

51. The method of claim 49, wherein:
the recording and outputting the trace data comprises recording the trace data in a real-time manner;
the outputting the trace data comprises outputting the trace data to the Trace Collection Entity according to the address of the Trace Collection Entity in a real-time manner.

52. The method of claim 49, wherein:
the method is executed by an originating mobile switching center server;
the trace activation message is a MAP-ACTIVATE_TRACE_MODE from a Home Subscriber Server or a Trace Session Activation from an Element Manager Server; and
the protocol signaling message is a BICC/ISUP IAM message or an SIP:INVITE message.

53. A method for providing end-to-end circuit service call tracing functionality, the method comprising:
receiving a first protocol signaling message which contains a first trace extension field, wherein the first trace extension field includes at least:
a Trace Reference;
a Trace Recording Session Reference; and
an address of a Trace Collection Entity;
starting a Trace Recording Session with the received Trace Reference and the received Trace Recording Session Reference;
recording and outputting trace data according to the first trace extension field;
sending a second trace extension field in a second protocol signaling message towards a next Network Element, wherein the second trace extension field is same as or derived from the first trace extension field;
stopping the Trace Recording Session when the stop triggering event for the Trace Recording Session occurs.

54. The method of claim 53, wherein:
the recording the trace data comprises recording the relevant trace data into a trace file; and
the method further comprises, after stopping the Trace Recording Session, outputting the recorded trace file to the Trace Collection Entity according to the address of the Trace Collection Entity.

55. The method of claim 53, wherein:
the recording the trace data comprises recording the trace data in a real-time manner;
the outputting the trace data comprises outputting the trace data to the Trace Collection Entity according to the address of the Trace Collection Entity in a real-time manner.

56. The method of claim 53, wherein:
the method is executed by a gateway mobile switching center server or a transit switching center;
the first protocol signaling message is a BICC/ISUP IAM message; and
the second protocol signaling message is a BICC/ISUP IAM message or an MAP SRI message.

57. The method of claim 53, wherein
the method is executed by a home location register;
the first protocol signaling message is an MAP SRI message; and
the second protocol signaling message is an MAP PRN message.

58. The method of claim 53, wherein
the method is executed by a media gateway control function entity;
the first protocol signaling message is a BICC/ISUP IAM message; and
the second protocol signaling message is an SIP:INVITE message.

59. The method of claim 53, wherein
the method is executed by a serving call session control function entity;
the first protocol signaling message is an SIP:INVITE message; and
the second protocol signaling message is an SIP:INVITE message.

60. A method for providing end-to-end circuit service call tracing functionality, the method comprising:
receiving a protocol signaling message which contains a trace extension field, wherein the trace extension field includes at least:
a Trace Reference;
a Trace Recording Session Reference; and
an address of a Trace Collection Entity;
starting a Trace Recording Session with the received Trace Reference and the received Trace Recording Session Reference;
recording and outputting trace data according to the trace extension field; and
stopping the Trace Recording Session when the stop triggering event for the Trace Recording Session occurs.

61. The method of claim 60, wherein:
the recording the trace data comprises recording the relevant trace data into a trace file; and
the method further comprises, after stopping the Trace Recording Session, outputting the recorded trace file to the Trace Collection Entity according to the address of the Trace Collection Entity.

62. The method of claim 60, wherein:
the recording the trace data comprises recording the trace data in a real-time manner;
the outputting the trace data comprises outputting the trace data to the Trace Collection Entity according to the address of the Trace Collection Entity in a real-time manner.

63. The method of claim 60, wherein:
the method is executed by a terminated mobile switching center server; and
the protocol signaling message is a BICC/ISUP IAM message or an MAP PRN message.

64. The method of claim 60, wherein:
the method is executed by a serving call session control function entity; and
the protocol signaling message is an SIP:INVITE message.
